(19) United States
(12) Patent Application Publication
(10) Pub. No.: US 2026/0258166 A1
(43) Pub. Date: Sep. 3, 2026

(54) POLYMER BLENDS COMPRISING POLYETHYLENE (METH) ACRYLIC ACID IONOMERS AND BORONIC ESTER CROSSLINKERS

(71) Applicant: Dow Global Technologies LLC, Midland, MI (US)

(72) Inventors: Tao Wang, Shanghai (CN); Yabin Sun, Shanghai (CN); Jeffrey M. Cogen, Collegeville, PA (US); Colin Li Pi Shan, Pearland, TX (US); Mao Chen, Shanghai (CN); Yang Zeng, Shanghai (CN); Peng Wen, Shanghai (CN)

(73) Assignee: Dow Global Technologies LLC, Midland, MI (US)

(21) Appl. No.: 19/489,488

(22) PCT Filed: Jun. 5, 2023
(86) PCT No.: PCT/CN2023/098362

§ 371 Date: Dec. 2, 2025

(51) Int. Cl. C08F 8/42

(52) U.S. Cl. CPC C08F 8/42; C08F 2800/20; C08F 2810/20

(57) ABSTRACT

Described in embodiments herein are polymer blends that may comprise a partially neutralized polyethylene (meth) acrylic acid ionomer and a boronic ester crosslinker comprising a Lewis acid with an accept number greater than 16.7, as determined by Gutmann-Beckett method. The polymer blend may comprise from 90 weight percent (wt. %) to 99 wt. % of the partially neutralized polyethylene (meth)acrylic acid ionomer, and from 1 wt. % to 10 wt. % of the boronic ester crosslinker, based on the total weight of the polymer blend. A process of manufacturing a molded article having improved heat resistance is disclosed herein, which may comprise melt mixing the partially neutralized polyethylene (meth)acrylic acid ionomer and the boronic ester crosslinker to form the polymer blend and molding the polymer blend into a molded article.

### TECHNICAL FIELD

Embodiments of the present disclosure are generally related to polymer blends, and are specifically related to polymer blends including ionomers and boronic ester crosslinkers.

### BACKGROUND

Ionomers are commonly used materials in various applications, because they have higher tensile strength, greater clarity, better abrasion resistance and higher stiffness than the precursor acid copolymers. For example, the ionomers of ethylene (meth)acrylic acid copolymers have found utility in many applications, such as food packaging, flexible packaging, cosmetic packaging, composite cans, and stand-up pouches.

Although ionomers may be utilized in many applications, ionomers have a limited usage temperature that restricts ionomers from being used in applications in which creep resistance is needed at temperatures above 60° C. For example, an ionomer may deform under stress at temperature above 60° C., which can limit the practical applications for which they can be used, such as cell phone protection cases, eyewear, footwear, transparent cleats, building-integrated photovoltaics, houseware, and kitchenware.

### SUMMARY

Accordingly, there is a need for polymer blends comprising ionomers and certain additives which improve creep resistance, while maintaining the physical and chemical character of the ionomer, such as mechanical strength and clarity.

This need is met by embodiments disclosed herein, which include polymer blends that include a partially neutralized polyethylene (meth)acrylic acid ionomer and boronic ester crosslinker comprising a Lewis acid with an accept number greater than 16.7. The boronic acid ester comprising a Lewis acid with an accept number greater than 16.7 is surprisingly effective as a crosslinker, which improves the mechanical performance of partially neutralized polyethylene (meth)acrylic acid ionomers at elevated temperatures.

In embodiments, polymer blends of this disclosure include a polymer blend comprising a partially neutralized polyethylene (meth)acrylic acid ionomer and a boronic ester crosslinker comprising a Lewis acid with an accept number greater than 16.7, as determined by Gutmann-Beckett method. The polymer blend may comprise from 90 weight percent (wt. %) to 99 wt. % of the partially neutralized polyethylene (meth)acrylic acid ionomer, and from 1 wt. % to 10 wt. % of the boronic ester crosslinker, based on the total weight of the polymer blend.

In embodiments, a process of manufacturing a molded article having improved heat resistance is disclosed, the method comprising melt mixing a partially neutralized polyethylene (meth)acrylic acid ionomer and a boronic ester crosslinker to form a polymer blend, and molding the polymer blend into a molded article. The boronic ester crosslinker may comprise a Lewis acid with an accept number greater than 16.7, as determined by Gutmann-Beckett method. The polymer blend may comprise from 90 weight percent (wt. %) to 99 wt. % of the partially neutralized polyethylene (meth)acrylic acid ionomer, and from 1 wt. % to 10 wt. % of the boronic ester crosslinker, based on the total weight of the polymer blend.

### BRIEF DESCRIPTION OF THE DRAWINGS

FIG. 1 depicts the chemical structures of boronic ester crosslinkers B1 through B6, as referenced in Examples 1-3;

FIG. 2 is graph depicting phosphine nuclear magnetic resonance (³¹P NMR) spectra of the boronic ester crosslinkers B1-B6; and

FIG. 3 is a graph depicting the stress (y-axis; MPa) and strain (x-axis; %) of films of Example 2 during a tensile/elongation test at 70° C.

### DETAILED DESCRIPTION

Unless otherwise defined, all technical and scientific terms used herein have the same meaning as commonly understood by one of ordinary skill in the art to which this disclosure belongs. In case of conflict, the specification, including definitions, will control.

Although methods and materials similar or equivalent to those described herein can be used in the practice or testing of various embodiments, suitable methods and materials are described herein.

Unless stated otherwise, all percentages, parts, ratios, etc., are by weight. When an amount, concentration, or other value or parameter is given as either a range, preferred range, or a list of lower preferable values and upper preferable values, this is to be understood as specifically disclosing all ranges formed from any pair of any lower range limit or preferred value and any upper range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having,” or any other variation thereof, are intended to cover a non-exclusive inclusion. For example, a process, method, article, or apparatus that comprises a list of elements is not necessarily limited to those elements but may include other elements not expressly listed or inherent to such process, method, article, or apparatus. Further, unless expressly stated to the contrary, “or” refers to an inclusive or and not to an exclusive or.

The transitional phrase “consisting essentially of” limits the scope of a claim to the specified materials or steps and those that do not materially affect the basic and novel characteristic(s) of the disclosure. Where applicants have defined an embodiment or a portion thereof with an open-ended term such as “comprising,” unless otherwise stated, the description should be interpreted to also describe such an embodiment using the term “consisting essentially of.”

Use of “a” or “an” are employed to describe elements and components of various embodiments. This is merely for convenience and to give a general sense of the various embodiments. This description should be read to include one or at least one and the singular also includes the plural unless it is obvious that it is meant otherwise.

In describing certain polymers, it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises copolymerized units of those monomers or that amount of the monomers, and the corresponding polymers and compositions thereof.

The term “copolymer” is used to refer to polymers formed by copolymerization of two or more monomers. Such copolymers include dipolymers consisting essentially of two copolymerized monomers.

“Ethylene acid copolymer” refers to acid copolymers comprising copolymerized units of an ethylene, and an α,β-ethylenically unsaturated carboxylic acid or an anhydride thereof, wherein at least 50 wt. % is comprised of ethylene.

“(Meth)acrylic acid” includes methacrylic acid and/or acrylic acid and “(meth)acrylate” includes methacrylate and/or acrylate.

The term “ionomer” refers to a polymer that is derived from a parent acid copolymer, as disclosed above, by partially or fully neutralizing the parent acid copolymer by one or more neutralizing agents.

“Polyethylene (meth)acrylic acid ionomer” refers to a partially or fully neutralized parent acid copolymer, wherein the parent acid copolymer includes copolymerized ethylene monomer and (meth)acrylic acid comonomer, and wherein at least 50 wt. % is comprised of ethylene monomer.

“Boronic ester” refers to an ester formed between a boronic acid and an alcohol. “Boronic ester crosslinker” is a boronic ester that may be added with an ethylene acid copolymer to form a polymer blend.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₅) alkyl group is an alkyl group having from 1 to 5 carbon atoms in its unsubstituted form. In some embodiments and general structures, certain chemical groups may be substituted by one or more substituents such as R^{S}. An R^{S} substituted chemical group defined using the “(Cₓ-C_{y})” parenthetical may contain more than y carbon atoms depending on the identity of any groups R^{S}. For example, a “(C₁-C₅)alkyl substituted with exactly one group R^{S}, where R^{S} is phenyl (—C₆H₅)” may contain from 7 to 11 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom or heteroatom of a corresponding unsubstituted compound or functional group is replaced by a substituent (e.g., R^{S}). The term “H” means a hydrogen or hydrogen radical that is covalently bonded to another atom. “Hydrogen” and “—H” are interchangeable, and unless clearly specified have identical meanings.

Various embodiments are directed to polymer blends including a partially neutralized polyethylene (meth)acrylic acid ionomer and a boronic ester crosslinker. The blend may include from 90 weight percent (wt. %) to 99 wt. % of the partially neutralized polyethylene (meth)acrylic acid ionomer and from 1 wt. % to 10 wt. % of the boronic ester crosslinker, based on the total weight of the polymer blend. In embodiments, the boronic ester crosslinker is a Lewis acid with an accept number greater than 16.7, as determined by Gutmann-Beckett method.

The partially neutralized polyethylene (meth)acrylic acid ionomer may be formed using any methods known in the art, such as copolymerizing a neutral non-ionic monomer with a monomer that contains a pendant acid group, such as an acrylic acid or methacrylic acid to form an ethylene acid copolymer. The ethylene acid copolymer can be prepared by standard free-radical copolymerization methods, using high pressure, operating in a continuous manner. Monomers are fed into the reaction mixture in a proportion which relates to the monomer's activity, and the amount desired to be incorporated. In this way, uniform, near-random distribution of monomer units along the chain is achieved. Unreacted monomers may be recycled. Additional information on the preparation of ethylene acid copolymers can be found in U.S. Pat. Nos. 3,264,272 and 4,766,174, each of which is hereby incorporated by reference in its entirety. The resulting copolymer has acid functionalities that are neutralized with a neutralizing agent. The ethylene acid copolymer can be used to produce ionomers by treatment with cations of a metal neutralizing agent. The source of the metal cations can be any convenient derivative, including but not limited to formates, acetates, hydroxides, nitrates, carbonates, and bicarbonates. In various embodiments, the ethylene acid copolymer can be treated with one or more cations such as calcium ion (Ca²⁺), lithium ion (Li⁺), aluminum ion (Al³⁺), scandium ion (Sc³⁺), iron ion (such as Fe²⁺ and Fe³⁺), yttrium ion (Y³⁺), titanium ion (Ti⁴⁺), zirconium ion (Zr⁴⁺), hafnium ion (Hf⁴⁺), vanadium ion (such as V²⁺, V³⁺, V⁴⁺ and V⁵⁺), cerium ion (such as Ce³⁺ and Ce⁴⁺), and magnesium ion (Mg²⁺); and mixtures thereof to form an ionomer. In some embodiments, the partially neutralized polyethylene (meth)acrylic acid ionomer comprises a sodium neutralizing agent.

In embodiments, 10 mole % to 90 mole % of total acid units of the partially neutralized polyethylene (meth)acrylic acid ionomer are neutralized. In referring to the total acid units neutralized, acrylic acid and methacrylic acid provide one acid unit. The calculation of percent neutralization is based on the number of acid units considered to be present as per above, and the number of metal equivalents added. The percent neutralization can be calculated according to the following equation:

$$Percent Neutralization = \frac{total cation valence}{total acid valence} \times 100 \%$$

The total acid units neutralized of the partially neutralized polyethylene (meth)acrylic acid ionomer may be from 10 mole % to 90 mole %, from 20 mole % to 80 mole %, from 30 mole % to 70 mole %, from 40 mole % to 60 mole %, or from 45 mole % to 55 mole %.

The partially neutralized polyethylene (meth)acrylic acid ionomer may comprise an ethylene acid copolymer, wherein the ethylene acid copolymer is a polymerized reaction product of ethylene and from 3 wt. % to less than 50 wt. % methacrylic acid comonomer, acrylic acid comonomer, or both methacrylic acid comonomer and acrylic acid comonomer. In embodiments, the ethylene acid copolymer comprises ethylene methacrylic acid copolymer, ethylene acrylic acid copolymer, or mixtures thereof. The partially neutralized polyethylene (meth)acrylic acid ionomer may comprise from 3 wt. % to less than 50 wt. %, such as from 3 wt. % to 40 wt. %, from 3 wt. % to 30 wt. %, from 3 wt. % to 25 wt. %, from 3 wt. % to 20 wt. %, from 5 wt. % to less than 50 wt. %, from 5 wt. % to 40 wt. %, from 5 wt. % to 30 wt. %, from 5 wt. % to 25 wt. %, from 5 wt. % to 20 wt. %, from 10 wt. % to 50 wt. %, from 10 wt. % to 40 wt. %, from 10 wt. % to 30 wt. %, from 10 wt. % to 25 wt. %, or from 10 wt. % to 20 wt. % methacrylic acid comonomer, acrylic acid comonomer, or both methacrylic acid comonomer and acrylic acid comonomer, based on the total weight of the partially neutralized polyethylene (meth)acrylic acid ionomer. In embodiments, the partially neutralized polyethylene (meth)acrylic acid ionomer can include methacrylic acid comonomer. In some embodiments, the partially neutralized polyethylene (meth)acrylic acid ionomer does not include acrylic acid comonomer.

In embodiments, the polyethylene (meth)acrylic acid prior to neutralization has a melt index of from 0.1 to 10.0 g/10 min, as determined in accordance with ASTM D1238 (210° C., 2.16 kg). For instance, the partially neutralized polyethylene (meth)acrylic acid ionomer can have a melt index of from 1.0 to 10.0 g/10 min, from 2.0 to 10.0 g/10 min, from 3.0 to 10.0 g/10 min, from 4.0 to 10.0 g/10 min. from 1.0 to 8.0 g/10 min, from 2.0 to 8.0 g/10 min, from 3.0 to 8.0 g/10 min, from 4.0 to 8.0 g/10 min, from 1.0 to 6.0 g/10 min, from 2.0 to 6.0 g/10 min, from 3.0 to 6.0 g/10 min, or from 4.0 to 6.0 g/10 min, as determined in accordance with ASTM D1238 (210° C., 2.16 kg). Additionally, in some embodiments of this disclosure, the polyethylene (meth)acrylic acid prior to neutralization has a density of from 0.920 to 0.980 g/cc as measured according to ASTM D792.

In embodiments, the polymer blend includes a boronic ester crosslinker in addition to the partially neutralized polyethylene (meth)acrylic acid ionomer, which may improve mechanical performance of the ionomer at elevated temperatures.

The boronic ester crosslinker may include a Lewis acid with an accept number greater than or equal to 16.7, as determined by Gutmann-Beckett method, which is described in U. Mayer, V. Gutmann and W. Gerger, Monat. Chem., 1975, 106, 1235-1257, which is hereby incorporated by reference in its entirety. In embodiments, the boronic ester crosslinker may include a Lewis acid with an accept number of from 16.7 to 130.

The boronic ester crosslinker may include a structure according to Formula (I), Formula (II), Formula (III), or combinations thereof:

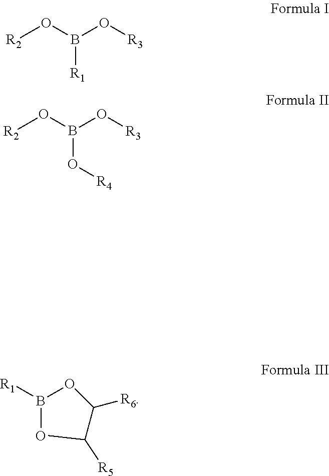

In embodiments, R₁ is a (C₁-C₈)alkyl group, R₂, R₃, and R₄ are independently selected from a (C₁-C₄)alkyl group, and R₅ and R₆ are independently selected from a (C₁-C₄)alkyl group and —H. However, when the boronic ester crosslinker comprises a structure according to Formula (I), at least two of R₁, R₂, and R₃ are independently selected from a (C₁-C₃)alkyl group, such as a C₂ alkyl group. Moreover, when the boronic ester crosslinker comprises a structure according to Formula (II), at least two of R₂, R₃, and R₄ are independently selected from a (C₁-C₃)alkyl group. When the boronic ester crosslinker comprises a structure according to Formula (III), at least one of R₅, and R₆ is independently selected from a (C₁-C₃)alkyl group.

Without intending to be bound by any particular theory, it is believed that the boronic ester crosslinker comprising a Lewis acid accept number of greater than 16.7 increases the efficacy of the boronic ester crosslinker as a crosslinker, which improves the mechanical performance of the partially neutralized polyethylene (meth)acrylic acid ionomers at elevated temperature. Further, in addition to the Lewis acid accept number of the boronic acid additive, it is believed that steric considerations of the chemical structures according to Formula (I), Formula (II), or Formula (III) may reduce interaction between the partially neutralized polyethylene (meth)acrylic acid ionomer and the boronic ester crosslinker, decreasing the efficacy of the boronic ester crosslinker as a crosslinker. This decreased crosslinking efficacy as a result of these steric issues may result in limited mechanical performance enhancement at elevated temperatures. For instance, longer alkyl chains present in the boronic ester crosslinker, such as the chemical structure according to Formula (I) where R₁, R₂, and R₃ are at least a C₄₊ alkyl group, may not provide improved crosslinking, which may limit or reduce mechanical performance at elevated temperatures.

In embodiments, the boronic ester crosslinker comprises a structure according to Formula (I), where R₂ and R₃ are independently selected from a (C₁-C₃)alkyl group, R₁ may be a (C₁-C₅)alkyl group, a (C₁-C₇)alkyl group, a (C₁-C₆)alkyl group, a (C₁-C₅) alkyl group, a (C₁-C₄)alkyl group, a (C₂-C₈)alkyl group, a (C₂-C₇)alkyl group, a (C₂-C₆)alkyl group, a (C₂-C₅) alkyl group, a (C₂-C₄)alkyl group, a (C₂-C₃)alkyl group, (C₃-C₈)alkyl group, a (C₃-C₇)alkyl group, a (C₃-C₆)alkyl group, a (C₃-C₅)alkyl group, a (C₃-C₄)alkyl group, a C₁alkyl group, a C₂ alkyl group, a C₃ alkyl group, a C₄ alkyl group, a C₅ alkyl group, a C₆ alkyl group, a C₇ alkyl group, or a C₈ alkyl group.

In embodiments, the boronic ester crosslinker comprises a structure according to Formula (III), where R₅ and R₆ are independently selected from a (C₁-C₄)alkyl group and —H, and where R₁ is a (C₁-C₇)alkyl group, a (C₁-C₆)alkyl group, a (C₁-C₅) alkyl group, a (C₁-C₄)alkyl group, a (C₂-C₈)alkyl group, a (C₂-C₇)alkyl group, a (C₂-C₆)alkyl group, a (C₂-C₅)alkyl group, a (C₂-C₄)alkyl group, a (C₂-C₃)alkyl group, (C₃-C₈)alkyl group, a (C₃-C₇)alkyl group, a (C₃-C₆) alkyl group, a (C₃-C₅)alkyl group, a (C₃-C₄)alkyl group, a C₁alkyl group, a C₂ alkyl group, a C₃ alkyl group, a C₄ alkyl group, a C₅ alkyl group, a C₆ alkyl group, a C₇ alkyl group, or a C₈ alkyl group.

In embodiments, the boronic ester crosslinker comprises a structure according to Formula (I), where R₂ and R₃ may be independently selected from a (C₁-C₃)alkyl group, a (C₁-C₂)alkyl group, a (C₂-C₃)alkyl group, a C₁alkyl group, a C₂ alkyl group, or a C₃ alkyl group, and where R₃ may be a (C₁-C₃)alkyl group, a (C₁-C₂)alkyl group, a (C₂-C₃)alkyl group, a C₁alkyl group, a C₂ alkyl group, and a C₃ alkyl group.

In embodiments, the boronic ester crosslinker comprises a structure according to Formula (II), where at least one of R₂, R₃, or R₄ may be a (C₁-C₄)alkyl group, a (C₁-C₃)alkyl group, a (C₁-C₂)alkyl group, a (C₂-C₄)alkyl group, a (C₂-C₃)alkyl group, a C₁alkyl group, a C₂ alkyl group, a C₃ alkyl group, or a C₄ alkyl group.

In embodiments, the boronic ester crosslinker comprises a structure according to Formula (II), where at least two of R₂, R₃, or R₄ may be independently selected from a (C₁-C₃) alkyl group, a (C₁-C₂)alkyl group, a (C₂-C₃)alkyl group, a C₁alkyl group, a C₂ alkyl group, and a C₃ alkyl group.

In embodiments, the boronic ester crosslinker comprises a structure according to Formula (III), where at least one of R₅ and R₆ may be a (C₁-C₃)alkyl group, a (C₁-C₂)alkyl group, a (C₂-C₃)alkyl group, a C₁alkyl group, a C₂ alkyl group, a C₃ alkyl group, or —H. In embodiments, at least one of R₅ and R₆ is —H.

In one or more embodiments, the boronic ester crosslinker may comprise a structure according to Formula (I), where R₂ and R₃ are independently selected from a (C₂-C₃)alkyl group. In other embodiments, the boronic ester crosslinker may comprise a structure according to Formula (II), where R₂, R₃, and R₄ are independently selected from a (C₂-C₃)alkyl group.

In some embodiments, the boronic ester crosslinker comprises tri-isopropyl borate, triethyl borate, n-butylboronic acid pinacol ester, n-butylboronic acid diethyl ester, n-butyl boronic acid cyclic propylene ester, or combinations thereof. In other embodiments, the boronic ester crosslinker is selected from the group consisting of tri-isopropyl borate, triethyl borate, n-butylboronic acid pinacol ester, n-butylboronic acid diethyl ester, n-butyl boronic acid cyclic propylene ester, and combinations thereof.

The polymer blend can be produced by any means known to one skilled in the art. It is substantially melt-processable and can be produced by combining the partially neutralized polyethylene (meth)acrylic acid ionomer and one or more boronic ester crosslinkers to produce a mixture and heating the mixture under a condition sufficient to produce the polymer blend. In embodiments, the partially neutralized polyethylene (meth)acrylic acid ionomer is formed prior to melt mixing the partially neutralized polyethylene (meth)acrylic acid ionomer and the boronic ester crosslinker to form the polymer blend. In other embodiments, the polyethylene (meth)acrylic acid ionomer, the boronic ester crosslinker, and the neutralizing agent are combined to form the polymer blend. Heating of the mixture can be carried out under a temperature of greater than or equal to 100° C., such as from 100° C. to 280° C., under a pressure that accommodates the temperature for a period from about 30 seconds to about 3 hours. The blend can be produced by melt-mixing the partially neutralized polyethylene (meth)acrylic acid ionomer and the boronic ester crosslinker to produce the polymer blend.

The polymer blend may include from 90 wt. % to 99 wt. % of the partially neutralized polyethylene (meth)acrylic acid ionomer, based on the total weight of the polymer blend. For instance, the polymer blend may comprise from 90 wt. % to 99 wt. %, from 91 wt. % to 99 wt. %, from 92 wt. % to 99 wt. %, from 93 wt. % to 99 wt. %, from 94 wt. % to 99 wt. %, from 95 wt. % to 99 wt. %, from 96 wt. % to 99 wt. %, from 97 wt. % to 99 wt. %, from 90 wt. % to 98 wt. %, from 91 wt. % to 98 wt. %, from 92 wt. % to 98 wt. %, from 93 wt. % to 98 wt. %, from 94 wt. % to 98 wt. %, from 95 wt. % to 98 wt. %, from 96 wt. % to 98 wt. %, or from 97 wt. % to 98 wt. % of the partially neutralized polyethylene (meth)acrylic acid ionomer, based on the total weight of the polymer blend.

The polymer blend may include from 1 wt. % to 10 wt. % of the boronic ester crosslinker, based on the total weight of the polymer blend. For instance, the polymer blend may comprise from 1 wt. % to 10 wt. %, from 2 wt. % to 10 wt. %, from 1 wt. % to 8 wt. %, from 2 wt. % to 8 wt. %, from 1 wt. % to 7 wt. %, from 2 wt. % to 7 wt. %, from 1 wt. % to 6 wt. %, from 2 wt. % to 6 wt. %, from 1 wt. % to 5 wt. %, from 2 wt. % to 5 wt. %, from 1 wt. % to 4 wt. %, from 2 wt. % to 4 wt. %, from 1 wt. % to 2 wt. %, or from 2 wt. % to 3 wt. % of the boronic ester crosslinker, based on the total weight of the polymer blend. Without intending to be bound by any particular theory, it is believed that a polymer blend including less than 1 wt. % of the boronic ester crosslinker may not provide sufficient improvement on the mechanical properties of molded articles comprising the polymer blend. Further, it is believed that a polymer blend including greater than 10 wt. % may provide diminishing improvements on the mechanical properties of molded articles comprising the polymer blend.

The polymer blend can additionally include small amounts of additives including plasticizers, stabilizers including viscosity stabilizers, hydrolytic stabilizers, primary and secondary antioxidants, ultraviolet light absorbers, anti-static agents, dyes, pigments or other coloring agents, inorganic fillers, fire-retardants, lubricants, reinforcing agents such as glass fiber and flakes, synthetic (for example, aramid) fiber or pulp, foaming or blowing agents, processing aids, slip additives, antiblock agents such as silica or talc, release agents, tackifying resins, or combinations of two or more thereof. Inorganic fillers, such as calcium carbonate, and the like can also be incorporated into the blend.

These additives may be present in the blends in quantities ranging from 0.01 to 40 wt %, 0.01 to 25 wt %, 0.01 to 15 wt %, 0.01 to 10 wt %, or 0.01 to 5 wt %. The incorporation of the additives can be carried out by any known process such as, for example, by dry blending, by extruding a mixture of the various constituents, by the conventional masterbatch technique, or the like.

Without intending to be bound by any particular theory, it is believed that a limiting factor for heat resistance of ionomers, such as partially neutralized polyethylene (meth)acrylic acid ionomers disclosed herein, is the melt temperature of small secondary crystals and ionic hopping of ionic clusters in the ionomer. Further, it is believed that polymer blends including the partially neutralized polyethylene (meth)acrylic acid ionomer and the boronic ester crosslinker comprising a Lewis acid accept number greater than or equal to 16.7 can increase the degree of crosslinking in the ionomer, which can improve mechanical performance of the ionomer at elevated temperatures. Further, it is believed that the carboxylate salt in the ionomer can interact with boronic esters with high Lewis acidity, resulting in an increased ionic cluster strength. This increased ionic cluster strength may reduce ionic hopping, which may result in improved mechanical performance of the ionomer or polymer blend comprising the ionomer at elevated temperatures. It is believed the ionic hopping of ionic clusters in ionomers are a cause of poor heat resistance of the ionomers.

According to various embodiments, the polymer blends can be used to form molded articles having increased creep resistance at elevated temperatures.

According to various embodiments, a process of manufacturing a molded article having improved heat resistance can include melt mixing the partially neutralized polyethylene (meth)acrylic acid ionomer and the boronic ester crosslinker to form the polymer blend, as disclosed herein, and molding the polymer blend into a molded article.

The melt mixing can include heating the partially neutralized polyethylene (meth)acrylic acid ionomer and a boronic ester crosslinker at a temperature of greater than or equal to 100° C., such as greater than or equal to 120° C., or greater than or equal to 140° C. In embodiments, the melt mixing includes heating the partially neutralized polyethylene (meth)acrylic acid ionomer and a boronic ester crosslinker at a temperature of from 100° C. to 280° C.

The molding can include any molding technique known in the art, such as but not limited to compression molding, blow molding, or injection molding.

In embodiments, molded articles formed from the polymer blends described herein can exhibit a tensile strength at break of greater than or equal to 12 MPa, such as greater than or equal to 14 MPa, as determined by the tensile/elongation test method at 60° C. as disclosed herein. The molded articles formed from the polymer blends described herein can exhibit a tensile strength at break of from 12 MPa to 30 MPa, such as from 12 MPa to 25 MPa, from 12 MPa to 20 MPa, from 15 MPa to 30 MPa, from 15 MPa to 25 MPa, or from 15 MPa to 20 MPa, as determined by the tensile/elongation test method at 60° C.

In embodiments, molded articles from the polymer blends described herein can exhibit a tensile strength at break of greater than or equal to 10 MPa, such as greater than or equal to 12 MPa, as determined by the tensile/elongation test method at 70° C., as disclosed herein. The molded articles formed from the polymer blends described herein can exhibit a tensile strength at break of from 10 MPa to 30 MPa, such as from 10 MPa to 25 MPa, from 10 MPa to 20 MPa, from 12 MPa to 30 MPa, from 12 MPa to 25 MPa, or from 12 MPa to 20 MPa, as determined by the tensile/elongation test method at 70° C.

In embodiments, molded articles formed from the polymer blends described herein can exhibit a Young's modulus of greater than or equal to 15 MPa, such as greater than or equal to 17 MPa at 60° C., as disclosed herein. In embodiments, molded articles formed from the polymer blends described herein can exhibit a Young's modulus of greater than or equal to 15 MPa, such as greater than or equal to 17 MPa, greater than or equal to 18 MPa, or even greater than or equal to 20 MPa at 70° C., as disclosed herein.

In embodiments, molded articles formed from the polymer blends described herein can exhibit an elongation % of less than 300%, such as less than 200%, or even less than 100%, as determined by the creep test method disclosed herein.

Molded articles formed from polymer blends comprising the partially neutralized polyethylene (meth)acrylic acid ionomer and the boronic ester crosslinker in accordance with various embodiments described herein can exhibit an improved creep resistance at elevated temperatures relative to molded articles formed from ionomers lacking the boronic ester crosslinker, or relative to polymer blends including boronic ester crosslinkers and copolymers that are non-neutralized.

### EXAMPLES

The following examples are provided to illustrate various embodiments, but are not intended to limit the scope of the claims. All parts and percentages are by weight unless otherwise indicated. Approximate properties, characters, parameters, etc., are provided below with respect to various working examples, comparative examples, and the materials used in the working and comparative examples. Further, a description of the raw materials used in the examples is as follows:

The polymer blends of the Examples and a portion of the Comparative Examples include ethylene methacrylic copolymer P1 (“P1”), which is an ethylene/15 wt % methacrylic acid ionomer partially neutralized (50%) using sodium cations, the ionomer having a density of 0.96 g/cm³ measured in accordance with ASTM D792 and a melt index, 12, of 4.5 g/10 min as determined in accordance with ASTM D1238 (190° C., 2.16 kg).

The polymer blends of a portion of the Comparative Examples include ethylene methacrylic copolymer P2 (“P2”), which is an ethylene/8.7 wt % methacrylic acid copolymer that is not neutralized, the ionomer having a density of 0.93 g/cm³ measured in accordance with ASTM D792 and a melt index, I₂, of 10.0 g/10 min as determined in accordance with ASTM D1238 (190° C., 2.16 kg).

The P1 and P2 ethylene methacrylic copolymer may be prepared by standard neutralization techniques, as disclosed in U.S. Pat. No. 3,264,272 (Rees), which is hereby incorporated by reference. The (meth)acrylic acid copolymer may be prepared by standard free-radical copolymerization methods, using high pressure, operating in a continuous manner. Monomers are fed into the reaction mixture in a proportion which relates to the monomer's reactivity, and the amount desired to be incorporated. In this way, uniform, near-random distribution of monomer units along the chain is achieved. Polymerization in this manner is well known, and is described in U.S. Pat. No. 4,351,931 (Armitage), which is hereby incorporated by reference. Other polymerization techniques are described in U.S. Pat. No. 5,028,674 (Hatch et al.) and U.S. Pat. No. 5,057,593 (Statz), both of which are also hereby incorporated by reference.

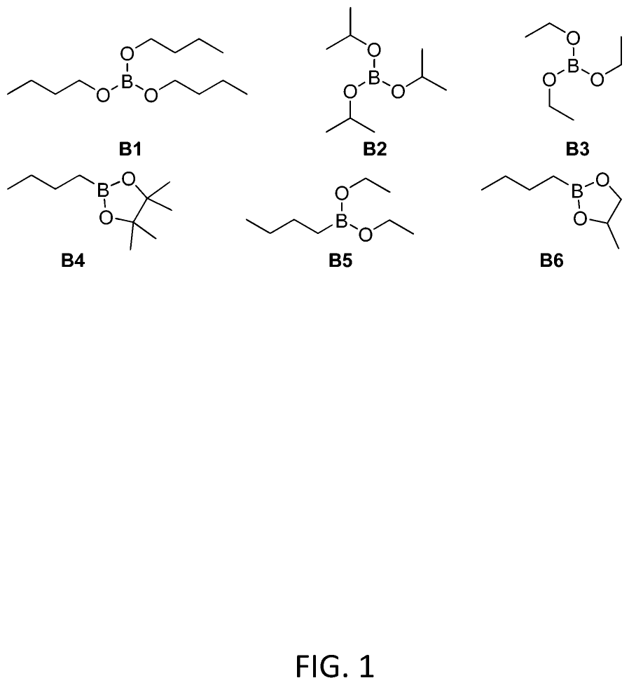

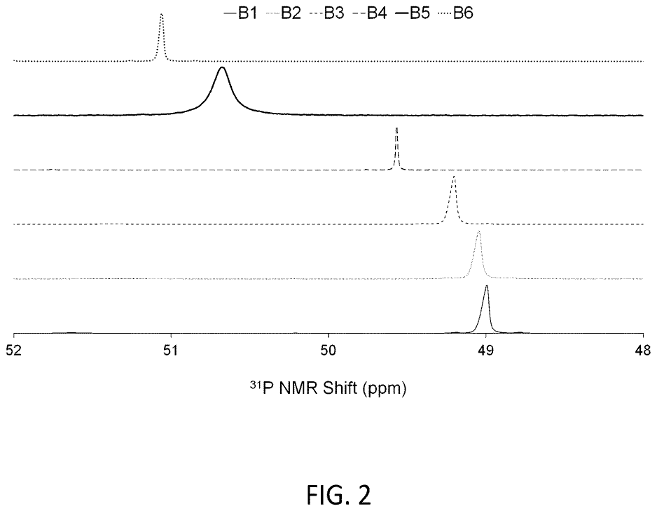

The polymer blends of the Examples and a portion of the Comparative Examples include the boronic ester crosslinkers of Table 1, and are identified as “B1” through “B6”. The chemical structure of the boronic ester crosslinkers B1-B6 are also shown in FIG. 1. Phosphine nuclear magnetic resonance (³¹P NMR) of the boronic ester crosslinkers in triethylphosphine oxide was analyzed to determine the Lewis Acid accept number of the boronic ester crosslinkers, as determined by the Gutmann-Beckett method. The chemical shifts of ³¹P NMR and calculated accept number of the boronic ester crosslinkers are reported in Table 1 and the ³¹P NMR spectra is shown in FIG. 2.

TABLE 1

| Boronic | | | |
|---|---|---|---|
| Esters | | Chemical Shifts | Accept |
| Additives | | of ³¹P (ppm) | Number |
| B1 | Tri-n-butyl borate | 48.49 | 16.6 |
| B2 | Tri-isopropyl borate | 48.54 | 16.8 |
| B3 | Triethyl borate | 47.70 | 17.1 |
| B4 | n-butylboronic acid pinacol ester | 49.06 | 17.9 |
| B5 | n-butylboronic acid diethyl ester | 50.18 | 20.4 |
| B6 | n-butyl boronic acid cyclic | 50.56 | 21.2 |
| | propylene ester | | |

The boronic ester crosslinkers B1, B2, and B3 are commercially available from Sigma-Aldrich as product numbers 236608, 197335, and T59307, respectively.

The boronic ester crosslinker B4 was synthesized as follows: a round-bottom flask equipped with a stir bar was charged with butylboronic acid (10.1 g, 0.1 mol), pinacol (11.8 g, 0.1 mol), anhydrous MgSO₄ (36 g, 0.3 mol) and anhydrous THF (100 ml). After stirring at room temperature for overnight, the mixture was filtered. The collected organic layer was concentrated under vacuum to give the crude product. The crude product extracted by anhydrous hexane and concentrated under vacuum to give target compound as a colorless oil, denoted as B4.

The boronic ester crosslinker B5 was synthesized as follows: a round-bottom flask equipped with a stir bar was charged with butylboronic acid (10.1 g, 0.1 mol), anhydrous ethanol (9.2 g, 0.2 mol), anhydrous MgSO₄ (36 g, 0.3 mol) and pentane (100 ml). After stirring at room temperature for overnight, the mixture was filtered. The collected organic layer was concentrated under vacuum to give the crude product. The crude product than purification by distillation under vacuum at 50° C. to give target compound as a colorless oil, denoted as B5.

The boronic ester crosslinker B6 was synthesized as follows: a round-bottom flask equipped with a stir bar was charged with butylboronic acid (10.1 g, 0.1 mol), propylene glycol (7.6 g, 0.1 mol), anhydrous MgSO₄ (36 g, 0.3 mol) and anhydrous THF (100 ml). After stirring at room temperature for overnight, the mixture was filtered. The collected organic layer was concentrated under vacuum to give the crude product. The crude product extracted by anhydrous hexane and concentrated under vacuum to give target compound as a colorless oil, denoted as B6.

Polymer blends were prepared in a HAAKE™ Rheomix 600 mixer from Thermo Fisher at about 160° C. for 20 minutes at a 50 rpm. The mixtures obtained from the blending process were dried in dehumidifier overnight before compression molding. Press Vulcanizer (GT-7014-H30C) was used for compression molding to make films for tensile/elongation testing and creep resistance testing. Plates temperature was set to 180° C. and pressure was set to 1.25 MPa. Mold thickness was set as 0.6-0.8 mm. After compression molding for 5 mins, the film was cooled down at room temperature. The samples were cut into 120 mm×28 mm×0.6 mm for tensile/elongation test and creep resistance test in the Examples that follow.

The tensile/elongation tests of Example 1 and Example 2 were investigated by using dumbbell-shaped specimens (effective gauge length=120 mm, width=28 mm, thickness=0.6 mm) via an Instron 5966 universal testing machine equipped with an oven and a 1 kN sensor. Measurements were performed using a preload of 0.01 N and a pulling speed of 1 mm/min until sample failure. Tensile tests were carried out at 60° C. in Example 1 and 70° C. in Example 2.

Creep resistance is a function of time, temperature, and loading weight (stress). A simple test was adopted to differentiate the creep resistance of ionomers with and without a boronic ester crosslinker. The creep test was conducted by measuring the dimensional change (vertical) of film specimens attached to a dead load in a cross flow air oven with a shelf rack to hold specimen holders. The creep resistance tests of Example 3 were investigated by using film samples having a thickness of 0.6 mm, a length of 76.2 mm, and a width of 25.4. The film sample was suspended in a heated oven with a 80 g loading (including the fixture) at testing temperature (75° C.). The dimensional change of the film was recorded and calculated by the change of film length divided by the original film length after 40 minutes. Test failure occurred if the film elongated to the point of touching the bottom of the oven (i.e. 1200% dimensional change

### Example 1—Tensile Strength and Elongation of Films at 60° C. Formed from Polymer Blends Including Boronic Ester Crosslinkers

Table 2 below provides polymer blends of Example (Ex.) 1-1, Ex. 1-2, and Comparative Examples (Comp.) A-F. The polymer blends were prepared by melt blending the ionomer with the boronic ester crosslinker, if present, according to Table 2. Films were formed from the polymer blends and the tensile/elongation test was carried out, as described herein. The tensile strength at break is reported in Table 2. The tensile strength change is also reported relative to the ionomer without the additive (Comp. A for P2 and Comp. E for P1). The elongation at break, and Young's Modulus are reported in Table 3. All tests were carried out at 60° C.

TABLE 2

| | | | | | | | Tensile |
|---|---|---|---|---|---|---|---|
| | Ethylene | | | | Tensile | | strength |
| | methacrylic | Neutralization | | Crosslinker | strength at | Derivations | changes vs |
| Example | copolymer | rate (%) | Crosslinker | (wt %) | break (MPa) | (MPa) | control (%) |
| Comp. A | P2 | 0 | / | / | 10.5 | 0.4 | Control P2 |
| Comp. B | P2 | 0 | B1 | 5% | 7.6 | 0.3 | −27.6% |
| Comp. C | P2 | 0 | B2 | 5% | 9.0 | 0.4 | −14.3% |
| Comp. D | P2 | 0 | B3 | 5% | 9.1 | 0.3 | −13.3% |
| Comp. E | P1 | 50 | / | / | 10.4 | 0.6 | Control P1 |
| Comp. F | P1 | 50 | B1 | 5% | 8.4 | 0.5 | −19.2% |
| Ex. 1-1 | P1 | 50 | B2 | 5% | 16.1 | 0.7 | +54.8% |
| Ex. 1-2 | P1 | 50 | B3 | 5% | 19.2 | 0.8 | +84.6% |

TABLE 3

| | Ethylene | | | | Elongation | | | |
|---|---|---|---|---|---|---|---|---|
| | methacrylic | Neutralization | | Crosslinker | at break | Derivations | Young's | Derivations |
| Example | copolymer | rate (%) | Crosslinker | (wt %) | (%) | (%) | Modulus | (MPa) |
| Comp. A | P2 | 0 | / | / | 995 | 12 | 16.85 | 0.8 |
| Comp. B | P2 | 0 | B1 | 5% | 980 | 16 | 16.25 | 0.8 |
| Comp. C | P2 | 0 | B2 | 5% | 998 | 17 | 15.7 | 0.6 |
| Comp. D | P2 | 0 | B3 | 5% | 1018 | 11 | 14.0 | 0.4 |
| Comp. E | P1 | 50 | / | / | 823 | 18 | 16.6 | 0.4 |
| Comp. F | P1 | 50 | B1 | 5% | 749 | 11 | 14.6 | 0.6 |
| Ex. 1-1 | P1 | 50 | B2 | 5% | 812 | 17 | 17.2 | 0.3 |
| Ex. 1-2 | P1 | 50 | B3 | 5% | 809 | 16 | 18.9 | 0.1 |

As shown in Table 2, films formed from polymer blends including a partially neutralized polyethylene (meth)acrylic acid ionomer and boronic ester crosslinker demonstrated improved tensile strength at 60° C. relative to films formed from polymer blends that did not include a boronic ester crosslinker (Comp. E). Further, films formed from comparative polymer blends where the polyethylene (meth)acrylic acid ionomer was non neutralized and included a boronic ester crosslinker (Comp. B-D) demonstrated decreased tensile strength relative to the polyethylene (meth)acrylic acid ionomer (Comp. A). That is, inclusion of the boronic ester crosslinker (B2 or B3) with the partially neutralized polyethylene (meth)acrylic acid ionomer (P1) improved the tensile strength, whereas inclusion of the boronic ester crosslinker (B2 or B3) with the polyethylene (meth)acrylic acid ionomer (P2) decreased the tensile strength. It is believed that the boronic ester crosslinkers could not interact strongly with P2. Further, the boronic ester additive may act as a plasticizer when combined with the non-neutralized polymer of P2, resulting in reduced mechanical strength.

### Example 2—Tensile Strength and Elongation of Films at 70° C. Formed from Polymer Blends Including Boronic Ester Crosslinkers

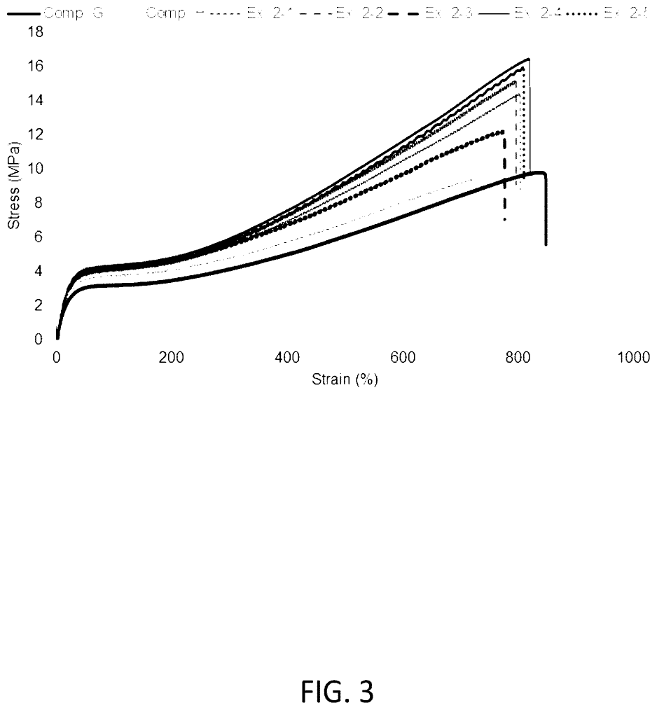

Table 4 below provides polymer blends of Example (Ex.) 2-1, through Ex. 2-5, and Comparative Example (Comp.) G and Comp. H. The polymer blends were prepared by melt blending the ionomer with the boronic ester crosslinker, if present, according to Table 4. Films were formed from the polymer blends and the tensile/elongation test was carried out, as described herein. The tensile strength at break is reported in Table 4. The tensile strength change is also reported relative to the ionomer without the additive (Comp. G). The elongation at break, and Young's Modulus are reported in Table 3. All tests were carried out at 70° C. FIG. 3 is a plot of stress/strain curve of the Examples during the tensile/elongation tests.

TABLE 4

| | | | | | | | Tensile |
|---|---|---|---|---|---|---|---|
| | Ethylene | | | | Tensile | | strength |
| | methacrylic | Neutralization | | Crosslinker | strength at | Derivations | changes vs |
| Example | copolymer | rate (%) | Crosslinker | (wt %) | break (MPa) | (MPa) | control (%) |
| Comp. G | P1 | 50 | / | / | 9.7 | 0.3 | Control P1 |
| Comp. H | P1 | 50 | B1 | 2.5% | 9.3 | 0.5 | −4.1% |
| Ex. 2-1 | P1 | 50 | B2 | 2.5% | 14.3 | 0.4 | +47.4% |
| Ex. 2-2 | P1 | 50 | B3 | 2.5% | 15.2 | 0.5 | +56.7% |
| Ex. 2-3 | P1 | 50 | B4 | 2.5% | 12.1 | 0.6 | +24.7% |
| Ex. 2-4 | P1 | 50 | B5 | 2.5% | 16.4 | 0.3 | +69.1% |
| Ex. 2-5 | P1 | 50 | B6 | 2.5% | 15.9 | 0.4 | +63.9% |

TABLE 5

| | Ethylene | | | | | | | |
|---|---|---|---|---|---|---|---|---|
| | methacrylic | Neutralization | | Crosslinker | Elongation | Derivations | Young's | Derivations |
| Example | copolymer | rate (%) | Crosslinker | (wt %) | at break % | % | Modulus | (MPa) |
| Comp. G | P1 | 50 | / | / | 847 | 13 | 14.1 | 1.9 |
| Comp. H | P1 | 50 | B1 | 2.5% | 727 | 18 | 14.7 | 0.6 |
| Ex. 2-1 | P1 | 50 | B2 | 2.5% | 804 | 12 | 21.2 | 1.5 |
| Ex. 2-2 | P1 | 50 | B3 | 2.5% | 796 | 17 | 20.2 | 1.3 |
| Ex. 2-3 | P1 | 50 | B4 | 2.5% | 776 | 15 | 20.6 | 1.3 |
| Ex. 2-4 | P1 | 50 | B5 | 2.5% | 820 | 11 | 22.8 | 1.0 |
| Ex. 2-5 | P1 | 50 | B6 | 2.5% | 807 | 12 | 21.8 | 0.5 |

As shown in Table 4, films formed from polymer blends including a partially neutralized polyethylene (meth)acrylic acid ionomer and boronic ester crosslinker comprising a Lewis acid accept number greater than 16.7 (Ex. 2-1 through 2-5) demonstrated improved tensile strength at 70° C. relative to films formed from polymer blends that did not include a boronic ester crosslinker (Comp. G), or polymer blends including a boronic ester crosslinker (B1) comprising a Lewis acid accept number of less than 16.7 (Comp. H). Further, as shown in Table 5, Ex. 2-1 through 2-5 resulted in a film having an increased Young's modulus relative to Comp. G and Comp. H. Further, it is believed that as B1 includes three C₄ alkyl chains, B1 results in increased steric hindrance during crosslinking with P1, which may reduce the extent of crosslinking, resulting in the observed poor mechanical properties of Comp. H.

### Example 3—Creep Resistance of Films at 75° C. Formed from Polymer Blends Including Boronic Ester Crosslinkers

Table 6 below provides polymer blends of Ex. 2-2, Ex. 2-4, Ex. 2-5, and Comp. G. The polymer blends were prepared by melt blending the ionomer with the boronic ester crosslinker, if present, according to Table 6. The polymer blends were compression molded to form films. The creep test was conducted by measuring the dimensional change (vertical) of the film attached to a deadload in a heated oven. Since creep resistance is a function of film size, time, temperature, loading (stress), and, the testing includes these variables defined in the test method (film samples having a thickness of 0.6 mm, a length of 76.2 mm, and a width of 25.4, 40 minutes, 80 g loading, and at 75° C.). The elongation % after 40 minutes is reported in Table 6. The elongation changes relative to the comparative example without a boronic ester crosslinker (Comp. G) is also reported in Table 6.

TABLE 6

| | Ethylene | | | | Elongation % | | Elongation |
|---|---|---|---|---|---|---|---|
| | methacrylic | Neutralization | | Crosslinker | after 40 | Derivations | changes vs |
| Example | copolymer | rate (%) | Crosslinker | (wt %) | mins | % | control |
| Comp. G | P1 | 50 | / | / | 313 | 11 | Control |
| Ex. 2-2 | P1 | 50 | B3 | 2.5% | 254 | 17 | −19% |
| Ex. 2-4 | P1 | 50 | B5 | 2.5% | 85 | 6 | −73% |
| Ex. 2-5 | P1 | 50 | B6 | 2.5% | 162 | 34 | −48% |

As shown in Table 6, films formed from polymer blends including a partially neutralized polyethylene (meth)acrylic acid ionomer and boronic ester crosslinker comprising a Lewis acid accept number greater than 16.7 (Ex. 2-2, Ex. 2-4, and Ex. 2-5) demonstrated improved creep resistance at 75° C. relative to films formed from polymer blends that did not include a boronic ester crosslinker (Comp. G). Accordingly, thermal creep resistance is improved by incorporating the boronic ester crosslinker comprising a crosslinker comprising a Lewis acid accept number greater than 16.7.

1. A polymer blend comprising:
a partially neutralized polyethylene (meth)acrylic acid ionomer,
a boronic ester crosslinker comprising a Lewis acid with an accept number greater than 16.7, as determined by Gutmann-Beckett method;
wherein the polymer blend comprises from 90 weight percent (wt. %) to 99 wt. % of the partially neutralized polyethylene (meth)acrylic acid ionomer, and from 1 wt. % to 10 wt. % of the boronic ester crosslinker, based on the total weight of the polymer blend.

2. The polymer blend of claim 1, wherein from 10 mole % to 90 mole % of total acid units of the partially neutralized polyethylene (meth)acrylic acid ionomer are neutralized.

3. The polymer blend of claim 1, wherein the partially neutralized polyethylene (meth)acrylic acid ionomer comprises a sodium neutralizing agent.

4. The polymer blend of claim 1, wherein the partially neutralized polyethylene (meth)acrylic acid ionomer comprises ethylene methacrylic acid copolymer, ethylene acrylic acid copolymer, or mixtures thereof.

5. The polymer blend of claim 4, wherein the partially neutralized polyethylene (meth)acrylic acid ionomer comprises from 3 wt. % to less than 50 wt. % methacrylic acid comonomer, acrylic acid comonomer, or both.

6. The polymer blend of claim 1, wherein the boronic ester crosslinker comprises a structure according to Formula (I), Formula (II), Formula (III), or combinations thereof: 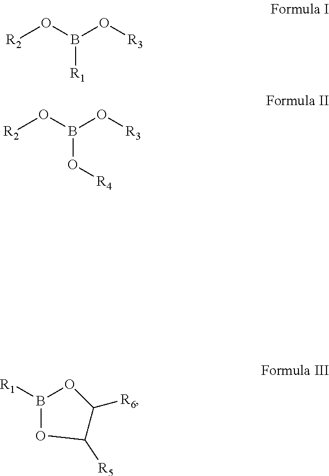
wherein:
R₁ is a (C₁-C₅)alkyl group;
R₂, R₃, and R₄ are independently selected from a (C₁-C₄)alkyl group;
R₅, and R₆ are independently selected from a (C₁-C₄)alkyl group and —H;
when the boronic ester crosslinker comprises a structure according to Formula (I), at least two of R₁, R₂, and R₃ are independently selected from a (C₁-C₃)alkyl group;
when the boronic ester crosslinker comprises a structure according to Formula (II), at least two of R₂, R₃, and R₄ are independently selected from a (C₁-C₃)alkyl group; and
when the boronic ester crosslinker comprises a structure according to Formula (III), at least one of R₅, and R₆ are independently selected from a (C₁-C₃)alkyl group.

7. The polymer blend of claim 6, wherein the boronic ester crosslinker comprises a structure according to Formula (I), and R₂ and R₃ are independently selected from a (C₂-C₃) alkyl group.

8. The polymer blend of claim 6, wherein the boronic ester crosslinker comprises a structure according to Formula (II), and R₂, R₃, and R₄ are independently selected from a (C₂-C₃) alkyl group.

9. The polymer blend of claim 6, wherein the boronic ester crosslinker comprises a structure according to Formula (III), wherein at least one of R₅ and R₆ is —H.

10. The polymer blend of claim 1, wherein the boronic ester crosslinker is selected from the group consisting of tri-isopropyl borate, triethyl borate, n-butylboronic acid pinacol ester, n-butylboronic acid diethyl ester, n-butyl boronic acid cyclic propylene ester, and combinations thereof.

11. The polymer blend of claim 1, wherein the polymer blend comprises from 1 wt. % to 7 wt. % of the boronic ester crosslinker.

12. A molded article comprising the polymer blend of claim 1.

13. A process of manufacturing a molded article having improved heat resistance, the method comprising:
melt mixing a partially neutralized polyethylene (meth)acrylic acid ionomer and a boronic ester crosslinker to form a polymer blend, wherein the boronic ester crosslinker comprises a Lewis acid with an accept number greater than 16.7, as determined by Gutmann-Beckett method; and
molding the polymer blend into a molded article;
wherein the polymer blend comprises from 90 weight percent (wt. %) to 99 wt. % of the partially neutralized polyethylene (meth)acrylic acid ionomer, and from 1 wt. % to 10 wt. % of the boronic ester crosslinker, based on the total weight of the polymer blend.

14. The process of claim 13, wherein the melt mixing comprises heating the partially neutralized polyethylene (meth)acrylic acid ionomer and a boronic ester crosslinker at a temperature of greater than or equal to 100° C.

15. The process of claim 13, wherein the molding comprises compression molding or injection molding.
